(19) United States
(12) Patent Application Publication
(10) Pub. No.: US 2026/0162028 A1
(43) Pub. Date: Jun. 11, 2026

(54) BUSINESS SERVICE ESTABLISHMENT METHOD AND APPARATUS, COMPUTER DEVICE, AND STORAGE MEDIUM

(71) Applicant: TENCENT TECHNOLOGY (SHENZHEN) COMPANY LIMITED, Shenzhen (CN)

(72) Inventor: Cheng WANG, Shenzhen (CN)

(21) Appl. No.: 19/315,777

(22) Filed: Sep. 1, 2025

Related U.S. Application Data
(63) Continuation of application No. PCT/CN2023/130004, filed on Nov. 6, 2023.

(30) Foreign Application Priority Data
Jun. 15, 2023 (CN) 202310713387.4

(51) Int. Cl. G06Q 10/063

(52) U.S. Cl. CPC G06Q 10/063

(57) ABSTRACT

A business service establishment method includes obtaining service demand information for a target business service, obtaining a target instance template preset for the target business service, creating, based on the service demand information and the target instance template, a service instance corresponding to the target business service, creating, based on component claim information included in the service instance, service components corresponding to the target business service and matching component types specified by the target instance template, respectively, obtaining pod sets corresponding to the service components, respectively, and each being created based on pod claim information included in a service component that is obtained from the service instance, and obtaining, based on the service instance, the service components, and the pod sets, a service model corresponding to the target business service and configured for providing the target business service to a demand side corresponding to the service demand information.

### CROSS-REFERENCE TO RELATED APPLICATIONS

This application is a continuation of International Application No. PCT/CN2023/130004, filed on November 6, 2023, which claims priority to Chinese Patent Application No. 2023107133874, entitled "BUSINESS SERVICE ESTABLISHMENT METHOD AND APPARATUS, COMPUTER DEVICE, AND STORAGE MEDIUM" and filed on June 15, 2023, the entire contents of both of which are incorporated herein by reference.

### FIELD OF THE TECHNOLOGY

This application relates to the field of computer technologies, and in particular, to a business service establishment method and apparatus, a computer device, a storage medium, and a computer program product.

### BACKGROUND OF THE DISCLOSURE

With the development of computer technologies, various business services appear. One business service is a software service for implementing a business, for example, a database service or a middleware service.

In the conventional technology, to deploy and establish any business service on a server, a developer is typically required to deploy the business service from the ground and from the beginning. Establishment of a generalized business service cannot be implemented, and there is a problem of low business service establishment efficiency.

### SUMMARY

In accordance with the disclosure, there is provided a business service establishment method including obtaining service demand information for a target business service, obtaining an instance template preset for the target business service as a target instance template, creating, based on the service demand information and the target instance template, a service instance corresponding to the target business service, creating, based on component claim information included in the service instance, service components corresponding to the target business service and matching component types specified by the target instance template, respectively, obtaining pod sets corresponding to the service components, respectively, and each being created based on pod claim information included in one of the service components that is obtained from the service instance, and obtaining, based on the service instance, the service components, and the pod sets, a service model corresponding to the target business service and configured for providing the target business service to a demand side corresponding to the service demand information.

Also in accordance with the disclosure, there is provided a computer device including a memory storing computer-readable instructions and a processor configured to execute the computer-readable instructions to obtain service demand information for a target business service, obtain an instance template preset for the target business service as a target instance template, create, based on the service demand information and the target instance template, a service instance corresponding to the target business service, create, based on component claim information included in the service instance, service components corresponding to the target business service and matching component types specified by the target instance template, respectively, obtain pod sets corresponding to the service components, respectively, and each being created based on pod claim information included in one of the service components that is obtained from the service instance, and obtain, based on the service instance, the service components, and the pod sets, a service model corresponding to the target business service and configured for providing the target business service to a demand side corresponding to the service demand information.

Also in accordance with the disclosure, there is provided a non-transitory computer-readable storage medium storing computer-readable instructions that, when executed by a processor, cause the processor to obtain service demand information for a target business service, obtain an instance template preset for the target business service as a target instance template, create, based on the service demand information and the target instance template, a service instance corresponding to the target business service, create, based on component claim information included in the service instance, service components corresponding to the target business service and matching component types specified by the target instance template, respectively, obtain pod sets corresponding to the service components, respectively, and each being created based on pod claim information included in one of the service components that is obtained from the service instance, and obtain, based on the service instance, the service components, and the pod sets, a service model corresponding to the target business service and configured for providing the target business service to a demand side corresponding to the service demand information.

### BRIEF DESCRIPTION OF THE DRAWINGS

To describe the technical solutions in embodiments of this application more clearly, the following briefly describes the accompanying drawings needed for describing the embodiments or the related art. Apparently, the accompanying drawings in the following descriptions show merely some embodiments of this application, and a person of ordinary skill in the art may still derive other drawings from these accompanying drawings without creative efforts.

FIG. 1 is a diagram showing an application environment of a business service establishment method in one embodiment;

FIG. 2 is a schematic flowchart of a business service establishment method in one embodiment;

FIG. 3 is a schematic diagram showing a service model in one embodiment;

FIG. 4 is a schematic flowchart of generating a configuration file corresponding to a pod in one embodiment;

FIG. 5 is a schematic diagram showing generation, by a pod configuration component, of a configuration file corresponding to a pod in one embodiment;

FIG. 6 is a schematic diagram showing initialization of a storage specification of a pod in one embodiment;

FIG. 7 is a schematic diagram showing monitoring of a running state of a service component by a probe in one embodiment;

FIG. 8 is a schematic diagram showing horizontal capacity expansion of a pod in one embodiment;

FIG. 9 is a schematic diagram showing vertical upgrade of a pod in one embodiment;

FIG. 10 is a schematic diagram showing generation of a data snapshot for a pod in one embodiment;

FIG. 11 is a schematic diagram showing restoring of a service instance in one embodiment;

FIG. 12 is a structural block diagram of a business service establishment apparatus in one embodiment; and

FIG. 13 is a diagram showing an internal structure of a computer device in one embodiment.

### DESCRIPTION OF EMBODIMENTS

Technical solutions in embodiments of this application will be clearly and completely described in the following with reference to the accompanying drawings in the embodiments of this application. It is clear that the described embodiments are merely some rather than all of the embodiments of this application. All other embodiments obtained by a person of ordinary skill in the art based on the embodiments of this application without creative efforts fall within the protection scope of this application.

To make the objectives, technical solutions, and advantages of this application clearer, the following further describes this application in detail with reference to the accompanying drawings and the embodiments. The specific embodiments described herein are only used for explaining this application, and are not used for limiting this application.

A business service establishment method provided in an embodiment of this application relates to a cloud technology.

Cloud storage is a new concept extended and developed on the concept of cloud computing. A distributed cloud storage system (a storage system for short below) refers to a storage system integrating a large number of different types of storage devices (alternatively referred to as storage nodes) in a network to collaborate via application software or application interfaces by using a function such as a cluster application, a grid technology, and a distributed storage file system and jointly provide data storage and service access functions to the outside.

A database may be briefly considered as a place in which an electronic file cabinet stores electronic files. A user may perform operations such as adding, querying, updating, and deleting data in the files. The so-called "database" is a data set that is stored together in a certain mode, can be shared with multiple users, has as little redundancy as possible, and is independent of an application.

A database management system (DBMS) is a computer software system designed for managing a database, and generally has basic functions such as storage, interception, security guarantee, and backup. The database management system may classify a database model supported by the database management system, for example, relational, or extensible markup language (XML), or classify the database model according to supported computer types, such as a server cluster or a mobile phone, or classify the database model according to a used query language, for example, structured query language (SQL) or XQuery, or classify the database model according to performance impulses, for example, a maximum scale and a highest running speed, or adopt another classification manner. Regardless of a classification mode, some DBMSs can implement cross-category, for example, support multiple query languages at the same time.

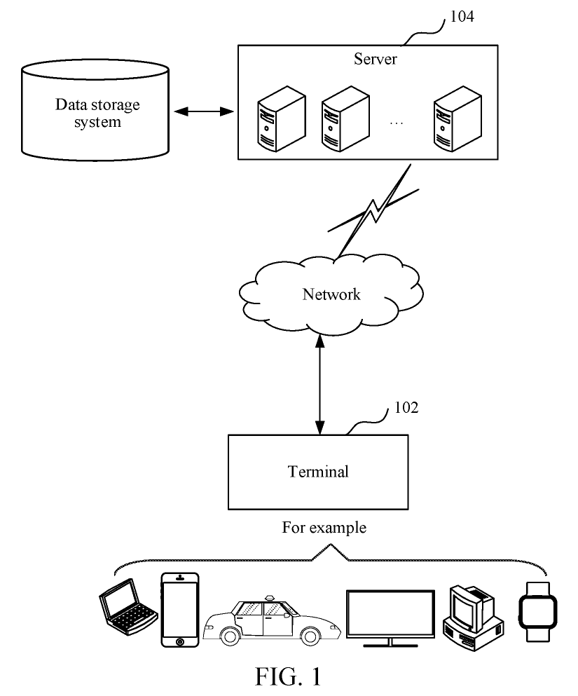

The business service establishment method provided in this embodiment of this application may be applied to an application environment as shown in FIG. 1. A terminal 102 communicates with a server 104 via a network. A data storage system may store data to be processed by the server 104. The data storage system may be integrated on the server 104, or may be placed on a cloud or another server. The terminal 102 may be, but is not limited to, various desktop computers, notebook computers, smartphones, tablet computers, Internet of Things devices, and portable wearable devices. The Internet of Things device may be a smart speaker, a smart television, a smart air conditioner, a smart in-vehicle device, or the like. The portable wearable device may be a smart watch, a smart band, a head-mounted device, or the like. The server may be an independent physical server, a server cluster or distributed system composed of a plurality of physical servers, or a cloud server providing cloud computing services. The terminal and the server may be directly or indirectly connected in a wired or wireless communication protocol, which is not limited in this application.

The business service establishment method provided in this embodiment of this application may be separately performed by the terminal 102 or the server 104, or may be jointly performed by the terminal 102 and the server 104. For example, the server may obtain service demand information for a target business service from the terminal. The server obtains an instance template preset for the target business service as a target instance template, and creates a service instance corresponding to the target business service based on the service demand information and the target instance template. The server creates a service component based on component claim information included in the service instance, to obtain service components corresponding to the target business service, where the component claim information is configured for indicating to create service components respectively matching component types specified by the target instance template. The server creates, based on pod claim information included in a service component, a pod set corresponding to the service component, to obtain pod sets respectively corresponding to the service components, where the pod claim information included in the service component is obtained from the service instance. Based on the service instance, the service components, and the pod sets respectively corresponding to the service components, a service model corresponding to the target business service is obtained. The service model is configured for providing the target business service to a demand side corresponding to the service demand information. The server may return an access entrance of the service model to the terminal, so that the terminal uses the target business service.

In this way, instance templates respectively corresponding to various business services are preset, so as to rapidly establish corresponding business services. For a target business service, personalized service demand information of the target business service and an instance template corresponding to the target business service are combined to obtain a service instance corresponding to the target business service. Service components corresponding to the target business service are created based on component claim information included in the service instance. Pod sets corresponding to the service components are created based on the pod claim information included in the service components. A service model for providing the target business service is formed by using the service instance corresponding to the target business service, the service components, and the pod sets respectively corresponding to the service components. The business service is abstracted into a three-layer structure model. The three-layer structure model includes a service instance, service components, and pod sets corresponding to the service components. The service instance manages and creates related information of the service components and the pod sets. The components manage and create related information of the respective pod sets, to implement ordered business service establishment. Various business services may be abstracted into a three-layer structure model. The universality is strong, the universality of business service establishment is ensured, and the efficiency of business service establishment is improved. Based on such a three-layer structure model, the business service is implemented in a cloud native manner.

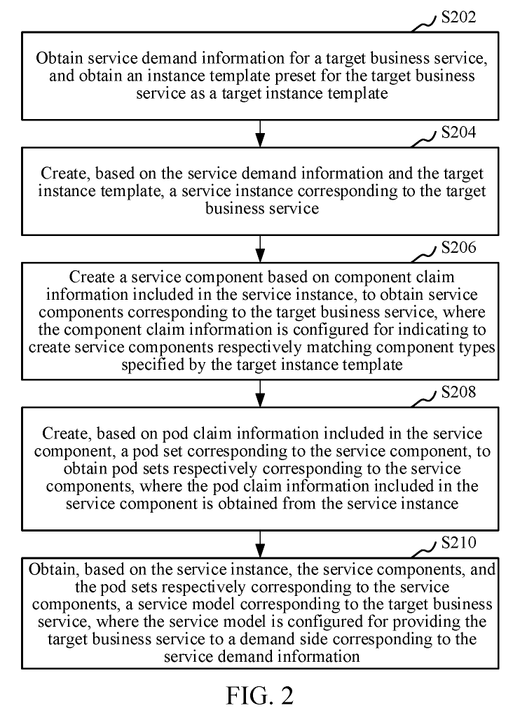

In one embodiment, as shown in FIG. 2, a business service establishment method is provided. A description is made by using an example in which the method is applied to a processing server. In this embodiment, a description is made by using an example in which the method is applied to the processing server. The method may alternatively be applied to a computer device. The computer device may be a terminal or a server. The method may alternatively be applied to a system including a terminal and a server, and is implemented by interaction between the terminal and the server. Referring to FIG. 2, the business service establishment method includes the following operations.

Operation S202: Obtain service demand information for a target business service, and obtain an instance template preset for the target business service as a target instance template.

The processing server is a server, configured to process a business service establishment request, and establish and deploy a business service on a related device. For example, the processing server may deploy the business service on a cloud server.

The target business service refers to a current to-be-deployed and to-be-established business service. For example, establishment entries of various business services may be provided to a user by using a terminal. The user may select a required business service therefrom on the terminal. The business service selected by the user is used as a target business service. Subsequently, the processing server establishes and deploys the target business service on a node cluster for the user, and returns an access entry of the successfully established target business service to the terminal, so that the user uses the target business service.

When selecting a required business service, the user may synchronously provide a service demand. The service demand may be a requirement for a service deployment site, a requirement for a service deployment scale, or the like. The service demand information refers to personalized demand information of a demand side of the target business service for the target business service. For example, for a database service, the service demand information may be a deployment region requirement, a deployment available area requirement, a deployment hard disk requirement, a deployment backup requirement, a deployment node requirement, or the like of the database service.

An object is instantiated to obtain a corresponding instance. The business service is instantiated to obtain a corresponding service instance. Various business services have respective characteristics, and corresponding instance templates may be preset for the various business services. The instance template is a specification template preset for characteristics of a business service. The instance template is configured for claiming general metadata required to establish the business service. For example, the instance template includes a component type required by the business service, a general component configuration parameter, and a general pod configuration parameter. A component type included in a business service is determined. For example, for a ClickHouse database service, ClickHouse includes two components, which are respectively zookeeper and clickhouse, where zookeeper is configured for metadata management of ClickHouse, and clickhouse is configured for data storage of ClickHouse. For example, the ClickHouse database service is deployed on a cluster including a plurality of nodes, zookeeper is responsible for scheduling and communication between nodes in the node cluster, and clickhouse is responsible for data storage and data operation on the nodes in the node cluster.

Specifically, the user determines a required target business service and service demand information for the target business service on the terminal, and the terminal transmits the service demand information for the target business service to the processing server, so that the processing server obtains an instance template preset for the target business service as a target instance template and deploys the target business service based on the service demand information and the target instance template.

The demand side may perform a business service establishment operation on a client. The client generates a business service establishment request in response to the business service establishment operation. The business service establishment request carries service type information and service demand information that correspond to the target business service. The client further transmits the business service establishment request to the processing server. After receiving the business service establishment request, the processing server parses the business service establishment request, to obtain service type information and service demand information, obtains, based on the service type information, an instance template preset for the target business service as a target instance template, and deploys the target business service based on the service demand information and the target instance template.

Operation S204: Create, based on the service demand information and the target instance template, a service instance corresponding to the target business service.

Specifically, after the service demand information and the target instance template for the target business service are determined, the service demand information and the target instance template are combined, to create a personalized service instance corresponding to the target business service. The service instance corresponding to the target business service is configured for indicating various metadata required for establishing the target business service.

In one embodiment, a service instance corresponding to a business service is Cluster, where Cluster is a business cluster instance, and Cluster represents a cluster instance created for the business service, and is implemented by K8s CRD. An instance template corresponding to the business service is ClusterPreset, where ClusterPreset is a business cluster instance template, and the business cluster instance template represents a specification template pre-configured by Cluster in advance. For example, ClusterPreset corresponding to a business service includes information such as an image, a cpu/memory, and a parameter configuration of a component corresponding to the business service. ClusterPreset is implemented by K8s CRD. K8s (Kubernetes) is a container orchestration system widely used in the cloud native field, has characteristics such as high scalability, high availability, fault self-healing, and open source ecology, and may, as a base, support large-scale production-level cluster deployment. CRD (Custom Resource Definition) is a resource type defined by a K8s user in K8s, and does not need to modify a K8s source code to create a custom API server. This function greatly improves scalability of K8s. The user-defined CRD may implement a corresponding functional characteristic by using a correspondingly designed CRD controller.

In one embodiment, the target instance template is a yaml file that is implemented based on K8s CRD and configured for customizing a resource type. The yaml file is filled with general information required by a target business service, and service demand information for the target business service is personalized demand information. The service demand information is filled into the yaml file, and a service instance corresponding to the target business service is created based on the filled yaml file.

Operation S206: Create a service component based on component claim information included in the service instance, to obtain service components corresponding to the target business service. The component claim information is configured for indicating to create service components respectively matching component types specified by the target instance template.

A business service is usually formed by one or more components, and different components are responsible for different functions in the business service. For example, for a ClickHouse database service, ClickHouse includes two components, namely, zookeeper and clickhouse, where zookeeper is configured for managing metadata of a ClickHouse database, and clickhouse is configured for storing data of the ClickHouse database. The zookeeper component and the clickhouse component cooperate to implement the ClickHouse database service.

The component claim information is configured for claiming and indicating metadata to be used by a component required for creating a business service. The service instance corresponding to the target business service includes component claim information corresponding to the target business service. The component claim information corresponding to the target business service includes information such as a component type, a component configuration parameter, and a starting dependency relationship between components required by the target business service.

The component type required by the target business service is determined based on a service characteristic of the target business service. The instance template corresponding to the target business service specifies the component type required by the target business service. For example, for a ClickHouse database service, ClickHouse includes two components, which are respectively zookeeper and clickhouse. An instance template corresponding to the ClickHouse database service specifies that two components, which are respectively zookeeper and clickhouse, are required. The starting dependency relationship between the components required by the target business service is also determined based on the service characteristic of the target business service. The instance template corresponding to the target business service specifies the starting dependency relationship between the components required by the target business service. For example, for a ClickHouse database service, ClickHouse includes two components, which are respectively zookeeper and clickhouse. Only after the component zookeeper is successfully started, the clickhouse component depending on zookeeper can be started. An instance template corresponding to the ClickHouse database service specifies a starting dependency relationship between the zookeeper component and the clickhouse component. The component configuration parameter of the component required by the target business service includes a general configuration parameter and an adjustable configuration parameter. The instance template corresponding to the target business service specifies the general configuration parameter. The adjustable configuration parameter may be adjusted according to a user demand, or a default parameter may be used. The instance template corresponding to the target business service specifies the default parameter of the adjustable configuration parameter.

Specifically, the processing server creates a service component based on component claim information included in the service instance. The component claim information includes component configuration parameters of various components required by the target business service, and corresponding components may be created based on the component configuration parameters, to obtain service components corresponding to the target business service.

Operation S208: Create, based on pod claim information included in a service component, a pod set corresponding to the service component, to obtain pod sets respectively corresponding to the service components. The pod claim information included in the service component is obtained from the service instance.

A function of one component may be implemented by one or more pods. The pod includes a group of related containers. The container is an isolation unit after unified packaging of related resources required for running an application. The container introduces application code, a library and dependency of the application code, any configuration file, and other system tools on which the application code depends. The container implements cross-platform portability of the application, isolation between processes, high efficiency of development and deployment, and the like. The pods required by one component forms a pod set corresponding to the components.

The pod claim information is configured for claiming and indicating metadata to be used for creating the pod set required by the components. The pod claim information corresponding to the target business service includes information such as a quantity of pods required by the components of the target business service, and a pod configuration parameter. For example, the pod claim information includes information such as a quantity of pods required by a component, an image required by the pods, a cpu/memory required by the pods, and a disk specification required by the pods. The service instance corresponding to the target business service includes the pod claim information corresponding to the target business service. The service component corresponding to the target business service may obtain the pod claim information from the service instance corresponding to the target business service. To be specific, the pod claim information is inherited from the service instance corresponding to the target business service.

The pod configuration parameter of the pod set required by the service component corresponding to the target business service includes a general configuration parameter and an adjustable configuration parameter. The instance template corresponding to the target business service specifies the general configuration parameter. The adjustable configuration parameter may be adjusted according to a user demand, or a default parameter may be used. The instance template corresponding to the target business service specifies the default parameter of the adjustable configuration parameter.

Specifically, the processing server creates a pod set corresponding to a service component based on pod claim information included in the service component. The pod claim information includes a pod configuration parameter of each pod in the pod set required by the service component of the target business service. A corresponding pod may be created based on the pod configuration parameter, and pods corresponding to a same service component form the pod set, to finally obtain pod sets respectively corresponding to the service components.

Operation S210: Obtain, based on the service instance, the service components, and the pod sets respectively corresponding to the service components, a service model corresponding to the target business service. The service model is configured for providing the target business service to a demand side corresponding to the service demand information.

Specifically, after sequentially creating the service instance corresponding to the target business service, the service components, and the pod sets respectively corresponding to the service components, the processing server combines the service components corresponding to the target business service and the pod sets respectively corresponding to the service components into a service model corresponding to the target business service, and provides, by using the service model corresponding to the target business service, the target business service to a demand side corresponding to the service demand information. In the service model corresponding to the target business service, the service instance is configured for global management. The service instance and the service component are in a parent-child relationship. The service component is configured for management of the pod set. The service component and the corresponding pod set are in a parent-child relationship. The pod set is configured for data processing for the target business service.

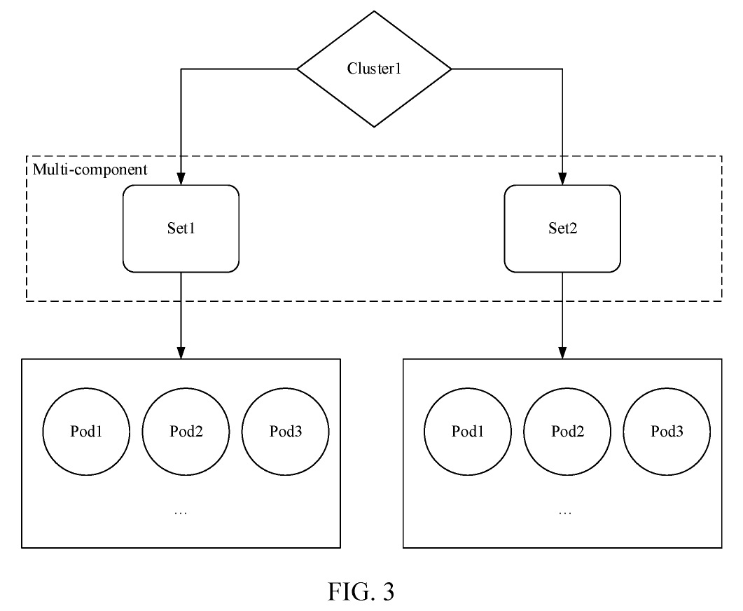

Using a ClickHouse database service as an example, a user needs the ClickHouse database service. The user may submit service demand information for the ClickHouse database service. The service demand information submitted by the user may include a quantity of pod shards, a quantity of pod replicas, and a disk specification required by the pods. The quantity of pod shards is configured for determining a quantity of pods on which data stored in the database needs to be distributed in a distributed manner. The quantity of pod replicas is configured for determining a quantity of pods to be used as backup pods to back up the data stored in the database. The disk specification required by the pods is configured for determining a capacity of the pods to store service data. The processing server receives a business service establishment request for a ClickHouse database service. The request carries service demand information. The processing server obtains ClusterPreset corresponding to the ClickHouse database service, and combines the service demand information and ClusterPreset to create a Cluster corresponding to the ClickHouse database service. The Cluster corresponding to the ClickHouse database service is marked as cluster1. A zookeeper component is created based on a zookeeper-related configuration parameter in cluster1 by using a Cluster manager (instance controller) designed based on K8s. The zookeeper component is marked as set1, and set1 inherits, from cluster1, a related configuration parameter of a pod required by the zookeeper component. A clickhouse component is created based on a clickhouse-related configuration parameter in cluster1 by using a Cluster manager (instance controller) designed based on K8s. The clickhouse component is marked as set2, and set2 inherits, from cluster1, a related configuration parameter of a pod required by the clickhouse component. A pod set required by the zookeeper component is created based on a related configuration parameter of a pod in the zookeeper component by using a set controller (component controller) designed based on K8s. A pod set required by the clickhouse component is created based on a related configuration parameter of a pod in the clickhouse component by using a set controller (component controller) designed based on K8s. Referring to FIG. 3, a service model of a ClickHouse database service required by a user includes a three-layer structure, consisting of cluster1 representing a ClickHouse database instance, set1 and set2 representing ClickHouse database components, and pods required by the ClickHouse database components. The processing server may return a service access entrance corresponding to the established ClickHouse database service to the user, and the user may use the ClickHouse database service based on the service access entrance.

After receiving a business request, a business end deployed for the target business service by the demand side may transmit the business request to the service model corresponding to the target business service by using the access entrance of the target business service. The service model distributes the business request, and distributes the business request to a specific pod. The pod receiving the business request performs corresponding business processing. The service model may distribute the business request based on a load balancing policy. The load balancing policy refers to determining, based on resource utilization of the pods in the pod set corresponding to the service component for processing the business request, a load condition of the pods in the pod set, and distributing the business request based on the load condition.

In the foregoing business service establishment method, instance templates respectively corresponding to various business services are preset, so as to rapidly establish corresponding business services. For a target business service, personalized service demand information of the target business service and an instance template corresponding to the target business service are combined to obtain a service instance corresponding to the target business service. Service components corresponding to the target business service are created based on component claim information included in the service instance. Pod sets corresponding to the service components are created based on the pod claim information included in the service components. A service model for providing the target business service is formed by using the service instance corresponding to the target business service, the service components, and the pod sets respectively corresponding to the service components. The business service is abstracted into a three-layer structure model. The three-layer structure model includes a service instance, service components, and pod sets corresponding to the service components. The service instance manages and creates related information of the service components and the pod sets. The components manage and create related information of the respective pod sets, to implement ordered business service establishment. Various business services may be abstracted into a three-layer structure model. The universality is strong, the universality of business service establishment is ensured, and the efficiency of business service establishment is improved. Based on such a three-layer structure model, the business service is implemented in a cloud native manner.

In one embodiment, the creating, based on the service demand information and the target instance template, a service instance corresponding to the target business service includes:

filling the target instance template with the service demand information, to obtain a service instance corresponding to the target business service, where the target instance template includes a component claim region and a pod claim region; and the component claim region is configured for indicating component claim information, and the pod claim region is configured for indicating pod claim information.

The target instance template includes a component claim region and a pod claim region. The component claim region is configured for indicating component claim information. To be specific, content included in the component claim region forms the component claim information. The pod claim region is configured for indicating pod claim information. To be specific, content included in the pod claim region forms the pod claim information.

Specifically, after obtaining the service demand information for the target business service, the processing server fills the target instance template with the service demand information, and obtains the service instance corresponding to the target business service based on the filled target instance template. The target instance template may be a template file in a key-value form. The service demand information includes at least one demand item. When the target instance template is filled, the target instance template is queried for keys respectively matching the demand items, and specific information of the demand items is used as a value corresponding to the matching key.

In the foregoing embodiment, the target instance template for the target business service is filled with the service demand information for the target business service, so that the service instance corresponding to the target business service may be rapidly created.

In one embodiment, the creating a service component based on component claim information included in the service instance, to obtain service components corresponding to the target business service includes:

determining, based on the component claim information included in the service instance, component types required by the target business service and component configuration information respectively corresponding to the component types; and separately creating, based on the component configuration information, a service component matching the corresponding component type, to obtain the service components corresponding to the target business service.

Specifically, the component claim information includes component types required by the target business service. The component type is configured for determining what type of component is required by the target business service. The component claim information includes component configuration information respectively corresponding to the component types required by the target business service. The component configuration information is configured for determining a configuration parameter of the component required by the target business service. The component configuration information includes various field information required to create a component of a corresponding component type. The processing server determines, based on the component claim information included in the service instance, component types required by the target business service and component configuration information respectively corresponding to the component types, and separately creates a service component matching a corresponding component type based on the component configuration information, to obtain service components corresponding to the target business service.

In the foregoing embodiment, the component claim information claims component types required by the target business service and component configuration information respectively corresponding to the component types, and service components corresponding to the target business service may be rapidly created based on the component claim information.

In one embodiment, the creating, based on pod claim information included in a service component, a pod set corresponding to the service component, to obtain pod sets respectively corresponding to the service components includes:

determining, for any one of the service components, a quantity of pods required by the service component based on pod claim information included in the service component, and creating to-be-configured pods matching the pods in quantity; determining, based on the pod claim information included in the service component, pod configuration information respectively corresponding to the to-be-configured pods, and initializing the corresponding to-be-configured pods based on the pod configuration information, to obtain configured pods; and obtaining, based on the configured pods, the pod set corresponding to the service component. Hereinafter, a to-be-configured pod is also referred to as a “candidate pod.”

Specifically, the pod claim information includes a quantity of pods required by the service component. The quantity of pods is configured for determining a number of pods required by the service component. The processing server may create to-be-configured pods matching the pods in quantity. The pod claim information includes pod configuration information of a pod required by a service component. The pod configuration information is configured for determining a configuration parameter of the pod. The pods have respectively corresponding pod configuration information. The processing server may initialize a corresponding to-be-configured pod based on the pod configuration information, to obtain a configured pod. Finally, the configured pods form a pod set corresponding to a service component.

In one embodiment, the initializing the to-be-configured pod includes initializing a namespace (NS) of the to-be-configured pod. K8s places a group of related resources in a same namespace by using the namespace, to achieve the objectives of resource isolation and permission limitation. Pods corresponding to a business service are placed in a same namespace. Pods corresponding to different business services are placed in different namespaces, to isolate the business services. For example, pods corresponding to a MySQL database service of user A are placed in namespace a, and pods corresponding to a MySQL database service of user B are placed in namespace b.

In one embodiment, the initializing the to-be-configured pod includes initializing a storage specification of the to-be-configured pod. The storage specification of a pod is configured for determining a storage capacity and a storage directory of data in the pod. The storage specification of the pod may be configured according to a user requirement.

In one embodiment, the initializing the to-be-configured pod includes initializing a network of the to-be-configured pod. The network of a pod is configured for communication between different pods.

In one embodiment, the initializing the to-be-configured pod includes initializing a configuration file of the to-be-configured pod. The configuration file of a pod is configured for running a process of the pod. The configuration file of the pod may be set by using ConfigMap built in K8s, or may be set by using another customized component.

In the foregoing embodiment, the pod claim information claims the quantity of pods required by the service component and the pod configuration information, and the pod sets respectively corresponding to the service components may be rapidly created based on the pod claim information.

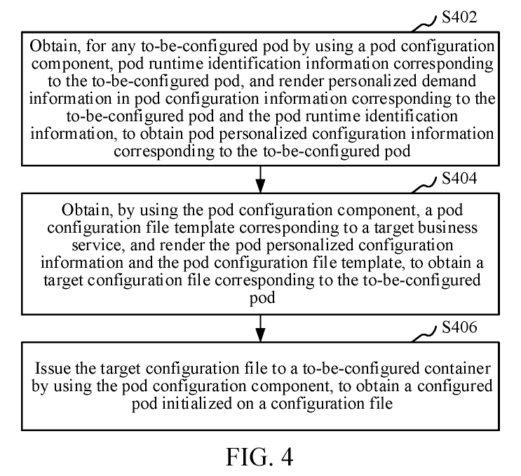

In one embodiment, as shown in FIG. 4, the initializing the corresponding to-be-configured pods based on the pod configuration information, to obtain configured pods includes the following operations.

Operation S402: Obtain, for any to-be-configured pod by using a pod configuration component, pod runtime identification information corresponding to the to-be-configured pod, and render personalized demand information in pod configuration information corresponding to the to-be-configured pod and the pod runtime identification information, to obtain pod personalized configuration information corresponding to the to-be-configured pod.

Operation S404: Obtain, by using the pod configuration component, a pod configuration file template corresponding to the target business service, and render the pod personalized configuration information and the pod configuration file template, to obtain a target configuration file corresponding to the to-be-configured pod.

Operation S406: Issue the target configuration file to a to-be-configured container (also referred to as a “candidate container”) by using the pod configuration component, to obtain a configured pod initialized on a configuration file.

The pod configuration component is a preset component for configuring a final configuration file required by the pod. The personalized demand information in the pod configuration information is determined based on the service demand information submitted by the user. For example, the personalized demand information is a quantity of pods to be created, and a storage specification of each pod. The pod runtime identification information is information for identifying the pod in a running process. For example, the pod runtime identification information includes at least one type of information such as a name, a domain name, an IP, and a state of a pod.

The pod configuration information is a related parameter before the pod is run, and the pod configuration information exists before the pod is created. The pod runtime identification information is a related parameter at pod runtime, and the pod runtime identification information exists only after the pod is created. For example, before a pod is created, only information required to create the pod, such as a quantity of pods to be created and an image of the pod, is known. After the pod is created, information identifying the pod, such as a name, a domain name, an IP, and a state of the pod, is generated.

Each business service has a corresponding pod configuration file template. The pod configuration file template is a template for a pod, which is provided by a business developer of a business to which the business service belongs. For example, various database services such as MySQL, MariaDB, PostgreSQL, SQL Server, ClickHouse, MongoDB, and Redis are specifically included. Using a MySQL database service as an example, the MySQL database service belongs to a MySQL database. An engineer of the MySQL database writes a configuration file template of a pod required by the MySQL database. To be specific, a database provider of the MySQL database writes a configuration file template of a pod required by the MySQL database.

The pod configuration file template includes an existing basic configuration parameter and a to-be-supplemented personalized configuration parameter. The basic configuration parameter is a general configuration parameter among different pods of a same type. The personalized configuration parameter is a configuration parameter specific to each pod. A complete configuration file may be obtained by supplementing the to-be-supplemented personalized configuration parameter in the configuration file template.

Specifically, the processing server may generate, by using the pod configuration component, target configuration files respectively corresponding to the to-be-configured pods, and issue the target configuration files to the corresponding to-be-configured pods, so as to obtain configured pods initialized on the configuration file.

When the target configuration file is generated, pod runtime identification information corresponding to the to-be-configured pod is first obtained by using the pod configuration component, and the personalized demand information in the pod configuration information corresponding to the to-be-configured pod and the pod runtime identification information corresponding to the to-be-configured pod are rendered. To be specific, the personalized demand information and the pod runtime identification information are combined, to obtain pod personalized configuration information corresponding to the to-be-configured pod. Then, a pod configuration file template corresponding to the target business service is obtained by using the pod configuration component, and the pod personalized configuration information and the pod configuration file template are rendered. To be specific, the pod personalized configuration information is filled into the pod configuration file template, to finally obtain a target configuration file corresponding to the to-be-configured pod.

In the foregoing embodiment, the personalized demand information and the pod runtime identification information in the pod configuration information are rendered by using the pod configuration component, to obtain the pod personalized configuration information, and the pod personalized configuration information and the pod configuration file template are rendered, to obtain the complete target configuration file. The personalized configuration file required by the pod may be rapidly generated by using the pod configuration component, thereby helping ensure that the pod runs normally according to demands.

In one embodiment, the obtaining, by using the pod configuration component, a pod configuration file template corresponding to the target business service includes:

obtaining, by using the pod configuration component, a template index of a pod configuration file template for the target business service from the pod claim information, and obtaining the pod configuration file template from a preset storage region based on the template index, where the pod configuration file template is submitted to the preset storage region for storage by using a template unification tool, and the template unification tool is configured for performing format unification on pod configuration file templates respectively provided by a plurality of business developers corresponding to a business type to which the target business service belongs.

A business service has a corresponding business type. For example, business types corresponding to various database services are databases, and business types corresponding to various middleware services are middleware. The service developer is an enterprise or a manufacturer of development services. For example, various databases such as MySQL, MariaDB, PostgreSQL, SQL Server, ClickHouse, MongoDB, and Redis are specifically included. A developer of the MySQL database provides a pod configuration file template required by the MySQL database. A developer of the ClickHouse database provides a pod configuration file template required by the ClickHouse database.

The template unification tool is a preset tool for unifying a configuration file template format. The template unification tool is configured for converting pod configuration files respectively provided by a plurality of service developers corresponding to a same service type into a unified format, so as to facilitate subsequent processing of the pod configuration component.

The pod configuration file templates respectively provided by the plurality of service developers corresponding to the same service type are uploaded to the template unification tool. The pod configuration file templates are converted into a unified format by using the template unification tool. The template unification tool submits the pod configuration file templates in the unified format into a preset storage region for storage.

The storing the pod configuration file templates in a preset storage region means storing the pod configuration file templates in a storage region provided in advance. The storage region provided in advance may be set according to an actual requirement. After a pod configuration file template is stored, a template index corresponding to the pod configuration file template may be obtained, and a corresponding pod configuration file template may be found rapidly by using the template index.

After the template index corresponding to the pod configuration file template is obtained by storing the pod configuration file template, the template index of the pod configuration file template may be pre-written into an instance template corresponding to a corresponding business service, so that the template index may be subsequently transferred between a service instance and a service component corresponding to the corresponding business service.

Specifically, the pod configuration file templates respectively provided by the plurality of service developers corresponding to the service type to which the target business service belongs may be pre-obtained. Formats of the pod configuration file templates are unified by using the template unification tool. The pod configuration file templates in the unified format are submitted to the preset storage region for storage. For any business service, a template index corresponding to a pod configuration file template of the business service is obtained, and the template index is written into a corresponding instance template.

For the target business service, when the corresponding pod configuration file template is obtained by using the pod configuration component, specifically, a template index of the pod configuration file template for the target business service may be obtained from the pod claim information by using the pod configuration component, and the pod configuration file template is obtained from the preset storage region based on the template index.

In the foregoing embodiment, the formats of the pod configuration file templates respectively provided by the plurality of service developers corresponding to the service type to which the target business service belongs are unified in advance by using the template unification tool, which can facilitate subsequent logical writing of the pod configuration component based on only one format. The template index of the pod configuration file template for the target business service is pre-written into the pod claim information, so that it can be convenient for the pod configuration component to rapidly obtain the pod configuration file template to generate the configuration file required by the pod.

In one embodiment, a configuration of a pod of each component required by a business service may be different, and a configuration needs to be maintained for each pod. The pods usually further need to sense information such as shard IDs, allocated CPUs, and allocated memories of the pods, and IPs and domain names of other pods in a cluster. The information is usually recorded in the configuration files of the pods, and is provided to processes in the pods for use. According to the method of this application, a configuration file of a pod is generated by using a ConfigCenter component (pod configuration component).

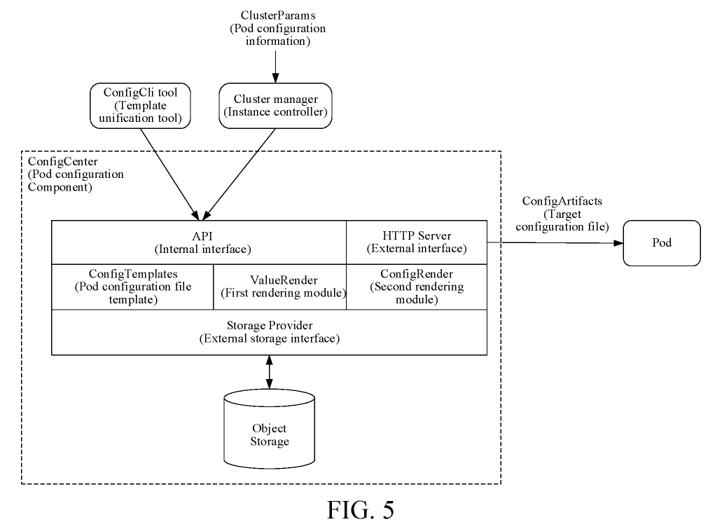

Referring to FIG. 5, ClusterParams represents a personalized parameter configuration of a demand side of a business service (i.e. a user of the business service). ClusterParams is typically obtained by an upper service according to a configuration of the demand side, and then is transferred to an instance controller Cluster Manager by using Cluster. The instance controller Cluster Manager transfers ClusterParams to the ConfigCenter component by accessing an API of the ConfigCenter component. The API is an internal interface.

ConfigTemplates indicates a configuration file template for a pod, and supports Go Template rendering by default. Using a database as an example, ConfigTemplates of different databases are compiled by engineers of the different databases. ConfigTemplates is submitted to an object storage (ObjectStorage) by a ConfigCli tool (i.e. a template unification tool). The ConfigCenter component may obtain ConfigTemplates from ObjectStorage by using StorageProvider. StorageProvider is an external storage interface for accessing an external object ObjectStorage.

ValueRender (first rendering module) represents rendering an incoming ClusterParams parameter and pod runtime information, namely combining ClusterParams and the pod runtime identification information, to obtain a required variable value (Value).

ConfigRender (second rendering module) is a central module of the ConfigCenter component, and may be considered as a stateless string template rendering function, for rendering the variable Value (Value) obtained in the previous operation and ConfigTemplates, namely combining the variable Value (Value) and ConfigTemplates, to generate a target configuration file ConfigArtifacts. ConfigArtifacts is a configuration file generated by the ConfigCenter component, and may be directly issued to a corresponding Pod for use by a process. The ConfigCenter component issues ConfigArtifacts to the pod by using an HTTP Server, where the HTTP Server is an external interface.

In one embodiment, the initializing the corresponding to-be-configured pods based on the pod configuration information, to obtain configured pods includes the following operations.

creating a target persistent volume claim matching a storage specification in the pod configuration information; generating a target persistent volume based on a target persistent volume template included in the target persistent volume claim, and associating the target persistent volume with a hard disk matching the storage specification in the pod configuration information; and binding the target persistent volume to the target persistent volume claim, and writing the target persistent volume claim into the to-be-configured pod, to obtain a configured pod initialized on the storage specification, where data in the configured pod initialized on the storage specification is configured for writing into the hard disk.

The pod configuration information includes a storage specification, and the storage specification is configured for indicating a storage capacity for storing business data by the pods.

A storage volume (Volume) is a channel for data transfer between a pod and an external storage device. Volume is configured for binding and mounting a directory in a hard disk and a directory in a pod, so that data in the pod may be stored in the hard disk. A persistent volume (Volume) refers to the directory on the hard disk, and has "persistence." To be specific, content in the directory is not cleared due to deletion of the pod. In this way, after the pod is restarted or reestablished on another node, the pod can still access the content by mounting Volume. "Persistence" means that all files written by the pod in the directory of the pod are stored in the hard disk, so that the directory has "persistence." The hard disk supports a plurality of disks such as a local hard disk and a cloud hard disk. The cloud hard disk allows dynamic plug-in. If a directory in a post and a directory on the cloud hard disk are bound and mounted together, the pod may be restored to another node. However, for the local hard disk, the pod can be restored to only an original node. The pod may be restored to another node unless data is migrated.

The persistent volume template (Storage Class, SC) is a preset storage class template. Different hard disks are classified into specific storage classes according to specifications, performance, and the like, and are selected from the storage classes according to demands, to flexibly control costs. A persistent volume (PV) represents storage abstraction of an underlying hard disk and is associated with a real hard disk. A persistent volume claim (PVC) represents an underlying storage object abstracted for pod use, and claims a required storage capacity (such as 100 G), Node exclusive or shared, file system or block device, or the like. The SC is a creation template of the PV, and is configured for dynamically creating the PV. The PV defines a directory persistently stored on the hard disk. The PVC describes attributes of persistent storage to be used by a pod, such as a Volume storage size and read and write permissions.

Specifically, the target business service may be a stateful service. The stateful service is a service that needs to persistently store data, a session, or a service state, and strictly depends on correctness and consistency of stored data during service starting, running, and restoration. For example, the database service is a stateful service, and specifically includes various database services such as MySQL, MariaDB, PostgreSQL, SQL Server, ClickHouse, MongoDB, and Redis. The middleware service is also a stateful service, and specifically includes various message middleware services such as RabbitMQ, RocketMQ, ActiveMQ, Kafka, ZeroMQ, and MetaMq. A plurality of pods under a component required by the stateful service usually needs to persistently store service data. Therefore, a PVC needs to be set for each pod to claim a required storage specification.

When a PVC is configured for a pod, a target PV matching a storage specification in the pod configuration information is created by invoking a related interface provided by K8s. A corresponding target PV is generated based on a target SC included in the target PVC. The target PV is associated with a hard disk (a local hard disk or a cloud hard disk) matching the storage specification in the pod configuration information. The target PV is bound to the target PVC, and the target PVC is written into a to-be-configured pod, to obtain a configured pod initialized on the storage specification.

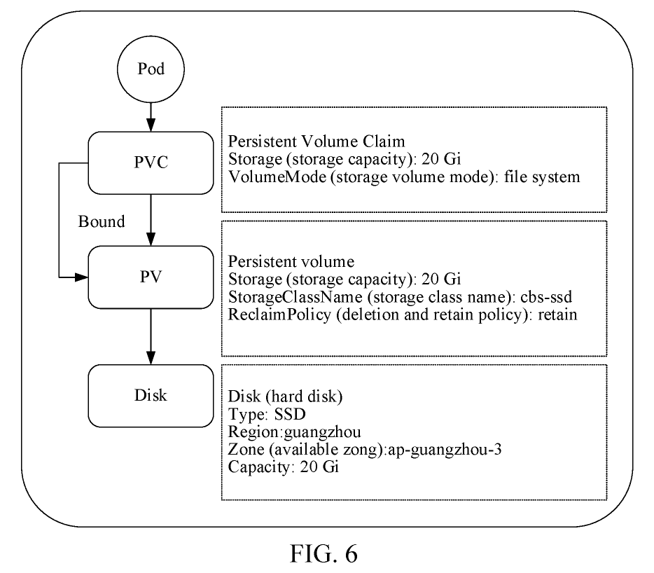

Referring to FIG. 6, the pod is mounted with a corresponding PVC to claim a required storage specification. For example, a storage capacity is 20 Gi, and a storage volume mode is a file system. A corresponding PV is bound to the PVC, and a specific PV persistent storage implementation is implemented by using a bottom layer CSI plug-in. PV attributes include a storage capacity (20 Gi), a storage class (Storage Class), and a deletion and retain policy (Retain indicates that a corresponding PV is retained when a PVC is deleted). A PV bottom layer is associated with a real hard disk system, and attributes thereof include a region, an available zone, a capacity (20 Gi), a type (SSD), and the like. In this way, data written into the directory of the pod may find the corresponding PV by using the PVC and find the hard disk by using the PV. Finally, the data is written into the directory of the hard disk.

In the foregoing embodiment, a storage specification of a pod is initialized, and service data stored in the pod may be finally stored on a remote hard disk by using a persistent volume claim, helping implement persistent storage of data.

In one embodiment, the business service establishment method further includes:

sequentially starting the service components based on a service component starting dependency sequence provided by the component claim information; monitoring a running state of each service component by using a probe provided for each service component, and triggering, after a probe provided for a service component with a high starting priority detects that each pod in a pod set managed by the service component is successfully started, starting a service component with a next starting priority; and returning a creation success message corresponding to the target business service to the demand side after the service components are successfully started.

Specifically, there is a starting dependency sequence among service components required by the target business service. The service components are sequentially started according to the starting dependency sequence, so that the target business service can operate normally. The component claim information provided by the service instance corresponding to the target business service records a service component starting dependency sequence. The service component starting dependency sequence is configured for sequentially starting the service components after a service component and a pod set corresponding to the service component are created, to implement running of the target business service.

After the service component and the pod set corresponding to the service component are created, corresponding probes are respectively set for the service components. The probe is configured for monitoring a running state of the service component. The running state of the service component is reflected by a running state of each pod in the pod set corresponding to the service component. After the service component and the pod set corresponding to the service component are created, the service components are sequentially started according to the service component starting dependency sequence. A running state of a service component to be started first is detected by using a probe. After pods under the service component to be started first are successfully started and run normally, a next service component is started. To be specific, after a probe provided for a service component with a high starting priority detects that pods in a pod set managed by the service component are successfully started, starting a service component with a next starting priority is triggered. After the service components are successfully started, it indicates that the target business service may run normally. In this case, a creation success message corresponding to the target business service may be returned to a demand side of the target business service.

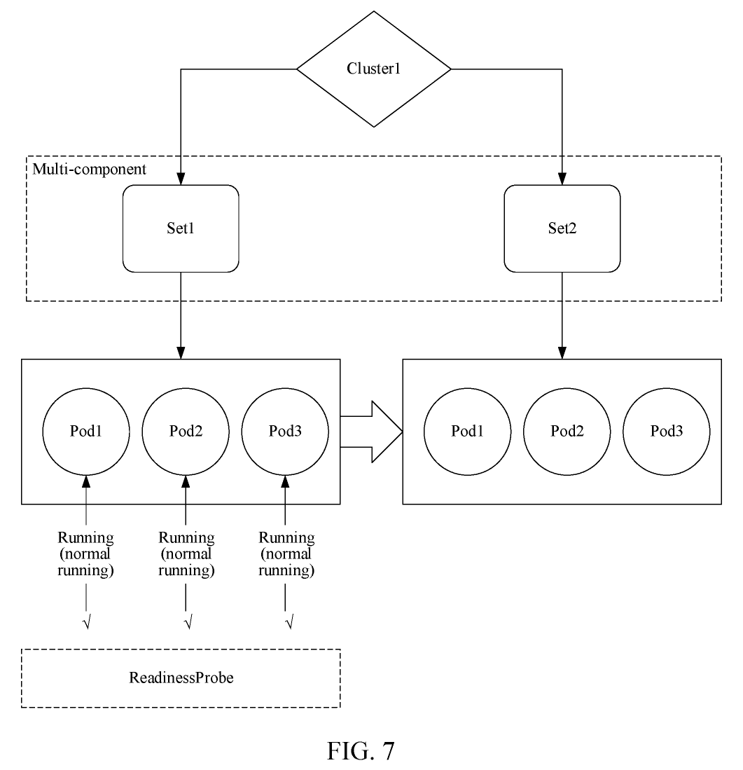

Using a ClickHouse database service as an example, referring to FIG. 7, a service model of the ClickHouse database service includes cluster1 representing a ClickHouse database instance, set1 and set2 representing ClickHouse database components, and a pod representing a database process. The ClickHouse database service includes two components, which are respectively zookeeper and clickhouse. Only after the zookeeper component is successfully started, the clickhouse component depending on the zookeeper component can be started. A component started first is detected by using a probe (K8s readinessProbe). After detection results of all pods under set1 indicate normal running, a next component is started sequentially.

If there is no front-back dependency relationship between some components, there may be no need to configure probe. In this case, pods between the components may be started in a parallel manner.

In the foregoing embodiment, based on the service component starting dependency sequence provided by the component claim information, the service components are started sequentially by using the probes for the service components, so as to ensure that the service components are started sequentially, thereby ensuring that the target business service can successfully run.

In one embodiment, the business service establishment method further includes:

obtaining a pod adjustment request for the target business service, where the pod adjustment request carries a pod adjustment parameter; updating, based on the pod adjustment parameter, pod claim information included in the service instance; and updating a corresponding service component and a corresponding pod set based on the updated pod claim information.

The pod adjustment request is configured for adjusting the pods, and may be specifically upgrading/downgrading or capacity expansion/reduction of the pods. The pod adjustment parameter is configured for indicating an adjustment demand for the pods. The capacity expansion/reduction of the pods refers to increasing the pods or reducing the pods. If a quantity of replicas needs to be increased, the quantity of the pods may be increased. The upgrading/downgrading of the pods refers to increasing the storage specification of the pods or reducing the storage specification of the pods. For example, a CPU/Memory/Disk required by the pods is vertically upgraded/downgraded.

Specifically, with increase or decrease of a business volume of the target business service, the pods in the service model corresponding to the target business service may be flexibly adjusted correspondingly. The processing server may obtain a pod adjustment request for the target business service. The pod adjustment request carries a pod adjustment parameter. Based on the pod adjustment parameter, the pod claim information included in the service instance is updated. For example, if the pod adjustment request is configured for capacity expansion of the pods, a quantity of pods in the pod claim information is adjusted. If the pod adjustment request is configured for upgrading the pods, the storage specification of the pods in the pod claim information is adjusted. If the service instance changes, the service component and the corresponding pod set are synchronously updated. For example, the component controller monitors the change of information in the service instance in real time. If it is detects that the corresponding pod claim information in the service instance changes, the corresponding pod set is synchronously updated based on updated pod claim information.

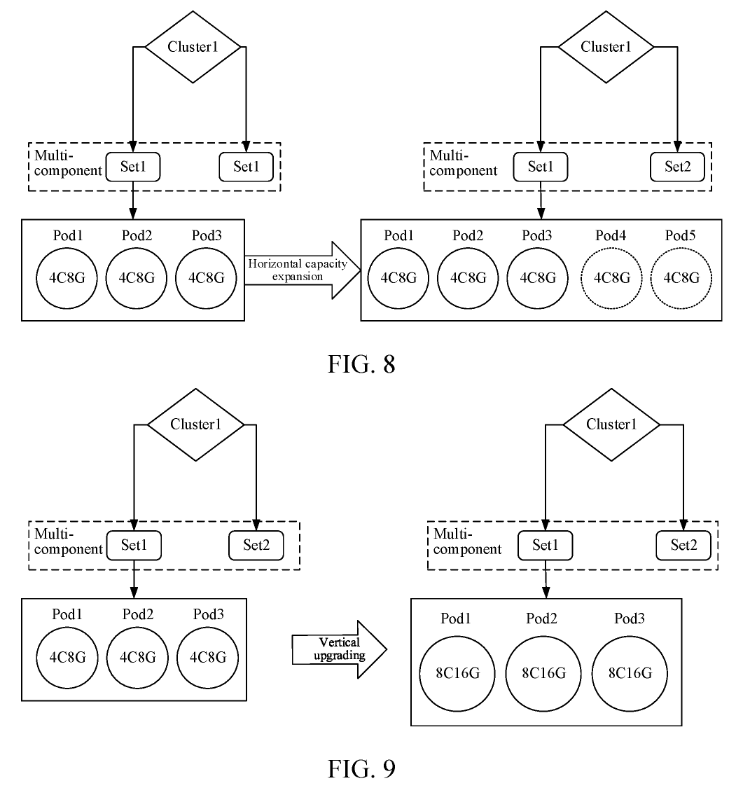

For example, using a database service as an example, a Cluster Manager (instance controller) implemented based on K8s CRD controls bottom layer K8s StatefulSet to implement dynamic capacity expansion/reduction (i.e. increase or decrease of a quantity of replicas, or horizontal capacity expansion/reduction) of the database, and implement vertical upgrading/downgrading (adjustment of the pod specification such as CPU/Memory/Disk) characteristic of the database. For the dynamic capacity expansion of the database, refer to FIG. 8. The quantity of the pods in set1 is increased by two. For the vertical upgrading of the database, refer to FIG. 9. The storage specification of the pods in set1 is increased from 4C8G to 8C16G. Correspondingly, the dynamic capacity reduction of the database is reducing the quantity of replicas, and the vertical downgrading of the database is reducing the storage specification.

Further, to not affect normal use of an upper business, when the dynamic capacity expansion/reduction or vertical upgrading/downgrading operation is performed, a related pod network traffic is removed in advance. After a bottom-layer pod subjected to capacity expansion/reduction or upgrading/downgrading detects normal running, a business traffic is accessed, so as to implement a smooth operation and maintenance operation that does not affect the business. Using a database service as an example, during running of the database service, if data stored in a database needs to be queried, a target pod may be determined, based on a load balancing policy, from pods for data storage, and required data is queried from the target pod. If pod1 for data storage needs to be vertically upgraded/downgraded, when the target pod is determined, the target pod is determined from other pods, other than pod1, for data storage. After pod1 is completely vertically upgraded/downgraded, pod1 may be considered when the target pod is determined.

In the foregoing embodiment, the pod set corresponding to the service component supports dynamic capacity expansion/reduction and vertical upgrading/downgrading, with high flexibility.

In one embodiment, the business service establishment method further includes:

backing up the service instance to obtain a backup instance in a case that destruction of the service instance is triggered; using a pod in the pod set corresponding to each service component as a first pod; creating, based on a persistent volume claim corresponding to the first pod, a persistent volume snapshot corresponding to the first pod, creating, based on a persistent volume corresponding to the first pod, a persistent volume snapshot content corresponding to the first pod, binding the persistent volume snapshot and the persistent volume snapshot content corresponding to the first pod, generating a data snapshot corresponding to the first pod based on the bound persistent volume snapshot and persistent volume snapshot content corresponding to the first pod, and associatively storing pod runtime identification information and the data snapshot corresponding to the first pod; and associatively storing the backup instance and the data snapshots respectively corresponding to the pods in the pod sets respectively corresponding to the service components.

The snapshot is configured for recording a system state and data at a time point. The persistent volume snapshot (Volume Snapshot, VSS) represents an abstract resource object of a persistent volume snapshot. The persistent volume snapshot content (Volume Snapshot Content, VSC) represents an abstract resource object of the persistent volume snapshot content and is associated with real back-end snapshot storage resources, such as COS/NFS. COS (Cloud Object Storage) is a cloud object storage service, which is a distributed and massive access system of unstructured objects. NFS (Network File System) is a network file system, which is a distributed and massive access system. The pod runtime identification information is configured for identifying a pod, and may be, for example, a name of the pod.

Specifically, when the service instance corresponding to the target business service is triggered to be destroyed, a snapshot backup is automatically initiated to back up data stored in the service instance and the pod set, to facilitate subsequent restoration of the service instance. When the service instance corresponding to the target business service is triggered to be destroyed, the service instance is backed up to obtain a backup instance. The backup instance includes metadata which is the same as that of the service instance, for restoring the service model corresponding to the target business service.

When the service instance corresponding to the target business service is triggered to be destroyed, the service data stored in the pod is backed up, so as to synchronously restore the service data stored in the pod when the service model is restored. A pod in the pod set corresponding to each service component is used as a first pod. For any first pod, a related interface provided by K8s is invoked to create a VSS corresponding to the first pod based on a PVC corresponding to the first pod, a related interface provided by K8s is invoked to create a VSC corresponding to the first pod based on a PV corresponding to the first pod, the VSS and the VSC corresponding to the first pod are bound, and a data snapshot corresponding to the first pod is generated based on the bound VSS and VSC corresponding to the first pod. Further, pod runtime identification information and the data snapshot corresponding to the first pod are stored associatively, and a pod to which the data snapshot belongs is indicated by using the pod runtime identification information.

Finally, the backup instance and the data snapshots respectively corresponding to the pods in the pod sets respectively corresponding to the service components are associatively stored, to facilitate subsequent data restoration.

In addition to initiating the snapshot backup for the service data in the pod when destroying of the service instance is triggered, the snapshot backup for the service data in the pod may alternatively be periodically initiated. The data snapshot may be made based on a Block technology, or the data snapshot may be made based on an XFS Reflink technology.

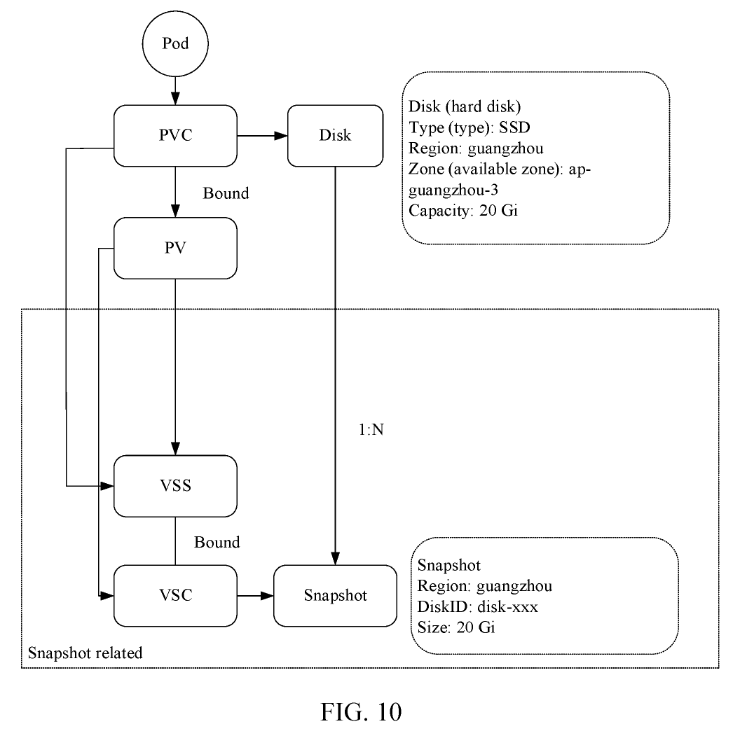

For example, for generation of a data snapshot of service data in a pod, referring to FIG. 10, a related interface provided by K8s is invoked to create a VSS from a PVC mounted on the pod, to create a VSC from a PV bound to the PVC mounted on the pod, to bind the VSS to the VSC, and to create a Snapshot by using the VSC based on data stored in a related directory in a hard disk associated with the PV corresponding to the pod. Snapshot requests may be initiated at different time points, and the generated Snapshots store data at corresponding time points. To be specific, N Snapshots may be generated for a same hard disk. Each Snapshot stores data at different time points in a related directory on the hard disk.

In the foregoing embodiment, when destroying of the service instance is triggered, the service data stored in the service instance and the pod set is backed up in time, helping subsequently rapidly restore the service instance.

In one embodiment, the business service establishment method further includes:

obtaining the backup instance in a case that restoration of the service instance is triggered; creating a service component based on component claim information included in the backup instance, to obtain restoration components; creating, based on pod claim information included in the restoration component, a pod set corresponding to the restoration component, to obtain pod sets corresponding to the restoration components; using a pod in the pod set corresponding to each restoration component as a second pod; and obtaining a corresponding data snapshot based on pod runtime identification information corresponding to the second pod, generating, based on the data snapshot corresponding to the second pod, a persistent volume snapshot and a persistent volume snapshot content corresponding to the second pod, generating a persistent volume corresponding to the second pod based on the persistent volume snapshot content corresponding to the second pod, generating a persistent volume claim corresponding to the second pod based on the persistent volume snapshot corresponding to the second pod, binding the persistent volume and the persistent volume claim corresponding to the second pod, and applying the persistent volume claim corresponding to the second pod to the second pod.

Specifically, the procedure of restoring the service instance may be initiated at any time according to a user demand. A backup instance backed up in advance is obtained when the service instance corresponding to the target business service is triggered to be restored. The service model is restored based on the backup instance. A data snapshot backed up in advance is obtained. The service data stored on the pod in the service model is restored based on the data snapshot.

When the service model is restored based on the backup instance, similar to a process of creating a service component and a corresponding pod set by using a service instance, a service component is created based on component claim information included in the backup instance, to obtain restoration components, and a pod set corresponding to the restoration component is created based on pod claim information included in the restoration component, to obtain pod sets respectively corresponding to the restoration components. The backup instance, the restoration components, and the pod sets respectively corresponding to the restoration components form the service model restored for the target business service.

When the service data is restored based on the data snapshot, a pod in the pod set corresponding to each restoration component is used as a second pod. For any second pod, a corresponding data snapshot is obtained based on pod runtime identification information corresponding to the second pod. A related interface provided by K8s is invoked to generate a VSS and a VSC corresponding to the second pod based on the data snapshot corresponding to the second pod. The related interface provided by K8s is invoked to generate a PV corresponding to the second pod based on the VSC corresponding to the second pod, and to generate a PVC corresponding to the second pod based on the VSS corresponding to the second pod. The PVC and the PV corresponding to the second pod are bound. The PVC corresponding to the second pod is applied to the second pod. The second pod may read the service data from a corresponding hard disk and store the service data in a directory of the second pod. The pod runtime identification information of pods created based on same metadata is the same. For example, before destroying, a name of a first pod is pod1, and during restoration, the name of the first pod is also pod1.

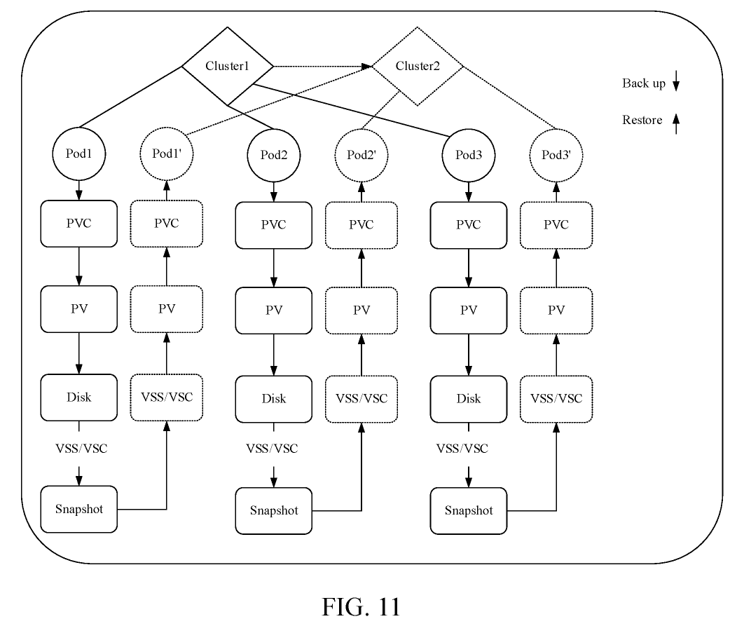

For example, referring to FIG. 11, three pods are created based on cluster1 by using corresponding sets. When cluster1 is destroyed, cluster1 is backed up, and Snapshots corresponding to pod1, pod2, and pod3 are separately generated. A procedure of restoring cluster1 may be initiated at any time according to demands within a data snapshot validity period. Cluster2 is generated based on a backup of cluster1, a set is created based on cluster2, and three pods, which are respectively pod1', pod2', and pod3', are created based on the set. For service data that needs to be stored in pod1', pod2', and pod3', Snapshots respectively corresponding to pod1', pod2', and pod3' are obtained. Starting from the Snapshots, a VSS and a VSC are created based on the Snapshots, and the VSS and the VSC are bound to each other. Then, a PVC is created by using the VSS as a data source, and a PV is created by using the VSC as a data source. The PVC and the PV are bound to each other. The PVC is mounted under the corresponding pod. Finally, pod1', pod2', and pod3' will run, and finally cluster2 will run normally.

In the foregoing embodiment, when restoration of the service instance is triggered, based on the backup instance backed up in advance and the data snapshot, the service model storing consistent service data before destroying can be rapidly restored, to ensure that the target business service continues to run.

In one embodiment, the target business service is a target database service. The service instance is configured for indicating metadata required to establish the target database service. The service components are respectively configured for implementing functions possessed by the target database service. The pods belonging to a same pod set cooperate to implement the functions provided by the corresponding service component.

Specifically, with wide popularization and production practices of cloud native technologies, more database services need to be migrated from conventional physical machine process management to cloud native container management, to implement rapid iteration, efficient deployment, elastic expansion, bottom-layer differential shielding, and the like of cloud native. The method of this application may be applied to a contained implementation of a database service, and is applicable to a plurality of database services. The database service typically includes a plurality of components. Therefore, to implement contained management of the database service, containing of the plurality of components needs to be considered. Different components are responsible for implementing different functions of a target database service. For example, a database service includes a database coordinating component and a database engine component. The database service is generally implemented by using node clusters. The database coordinating component is configured for coordinating communication between the node clusters. The database engine component is configured for performing data storage on service data in a database, to implement service data management. The pods belonging to the same pod set cooperate to implement a function provided by a corresponding service component. For example, for a database engine component, a plurality of shard pods and a plurality of replica pods may be provided. One shard pod is responsible for managing a part of service data. The service data managed by the shard pods is combined into complete service data stored in a database, and one replica pod is configured for data backup of a part of service data. For a same part of service data, the plurality of replica pods may be provided for multiple backups.

In a specific embodiment, the method of this application may be applied to a scenario in which a cloud manufacturer provides a database service for a customer. The database service is a typical stateful service, and needs to persistently store data, a session, or a service state.

In a conventional technology, a single component management and persistent storage of a stateful service are generally implemented by using StatefulSet in K8s. Core capabilities are fixed pod name and data persistent storage. However, general management capabilities of a plurality of databases and a plurality of components cannot be implemented, for example, core capabilities such as a component dependency relationship, differential configuration, dynamic capacity expansion/reduction, dynamic upgrading/downgrading, and data backup and restoration. The method of this application implements a general model abstraction of the database service and the foregoing database core management capability.

The database service includes a plurality of components: A common database service is usually formed by one or more components. Therefore, to implement contained management of the database service, containing of the plurality of components needs to be considered. According to the method of this application, a common database service is abstracted into a general three-layer resource model, cluster-> sets-> pods sequentially from top to bottom, which correspond to a database instance, a database component, and a database process pod, respectively. Containing of a plurality of database services may be supported by using such a three-layer resource model. When purchasing a database service from a cloud manufacturer, a customer may select a database type and personalized demand information for the database service. After receiving a customer request, a processing server of the cloud manufacturer obtains an instance template corresponding to the database type required by the customer, and rapidly creates a database instance required by the customer based on the personalized demand information of the customer in combination with the instance template. The database instance claims metadata required to implement the database service required by a user, creates a database component based on component claim information in the database instance, and creates a database process pod corresponding to the database component based on pod claim information inherited by the database component from the database instance. Using a ClickHouse database service as an example, the customer may open a business service creation page of the ClickHouse database service on a client provided by the cloud manufacturer for the customer. The business service creation page includes components required by the ClickHouse database service: zookeeper and clickhouse. The demand side may separately configure a corresponding parameter for each component, to obtain service demand information. The customer may configure information such as a quantity of shards, a quantity of pods under a shard, a pod specification, and a quantity of replicas corresponding to the shard for each component. The client generates a business service establishment request based on the service type information and the service demand information of the ClickHouse database service, and transmits the business service establishment request to the processing server of the cloud manufacturer. The processing server creates a service instance cluster1 corresponding to the ClickHouse database service based on the service type information and the service demand information, creates a zookeeper component set1 and a clickhouse component set2 under cluster1, creates a pod required by the customer under set1, and creates a pod required by the customer under set2.

In addition, there is usually a starting dependency sequence between the components of the database service. For example, the ClickHouse database service includes two components, namely zookeeper and clickhouse. Only after the zookeeper component is successfully started, the clickhouse component depending on the zookeeper component can be started. A database instance records a starting dependency sequence of database components. According to the method of this application, a component started first is detected by using a probe (K8s readinessProbe). After detection results of all pods under this component indicate normal running, a next component is started sequentially.

In addition, the components of the database service are differently configured, a plurality of components of the database service are specifically configured, and different pods in each component may have different configurations. In the method of this application, after a pod is created, a configuration file required by the pod is generated, and the configuration file is rapidly issued to the pod to implement a differential configuration for the pod.

In addition, the database needs to be subjected to dynamic capacity expansion/reduction. As the fluctuation of an upper business volume supported by the database service is increased or reduced, a bottom-layer database service needs to support dynamic capacity expansion/reduction of a quantity of replicas, and normal running of the upper business cannot be affected. The database also needs to be vertically upgraded/downgraded. The database service not only needs capacity expansion/reduction of the quantity of replicas, but also an existing pod specification (for example, CPU/Memory/Disk) may be vertically upgraded/downgraded. For example, the CPU/Memory is upgraded from 4C8G to 8C16G, and normal running of the upper business cannot be affected. If dynamic capacity expansion/reduction or vertical upgrading/downgrading needs to be performed on the database, it may be implemented by modifying the database instance. If it is detected that the database instance is updated, synchronous update is performed, to implement the dynamic capacity expansion/reduction or the vertical upgrading/downgrading. When dynamic capacity expansion/reduction or vertical upgrading/downgrading is performed, a related pod network traffic is removed in advance. After the dynamic capacity expansion/reduction or the vertical upgrading/downgrading is completed, a business traffic is accessed by the related pod, so as to implement a smooth operation and maintenance operation that does not affect the business.

In addition, the database needs to be backed up and restored. To ensure the security and reliability of the data, a snapshot needs to be periodically made in a normal running process. For example, a full database snapshot backup is performed every one hour. An automatic snapshot backup is further needed when the database service is destroyed, so that a database instance with complete data may be rapidly restored based on the backup when needed. According to the method of this application, the database instance may be backed up and the service data stored in the database process pod may be backed up as required. The database component and the database process pod are created depending on the database instance, and only the database instance needs to be backed up, so that the database component and the database process pod may be rapidly restored, but the service data stored in the database process pod needs to be additionally restored. The generated snapshots may support a variety of back-end storage, such as COS object storage, NFS, and cloud snapshot, and the cost is much lower than that of an ordinary cloud hard disk. Therefore, significant cost reduction and efficiency improvement can be brought to the business.

Although the operations are displayed sequentially according to the instructions of the arrows in the flowcharts involved in the embodiments as described above, these operations are not necessarily performed sequentially according to the sequence instructed by the arrows. Unless otherwise explicitly specified in this application, execution of the operations is not strictly limited, and the operations may be performed in other sequences. Moreover, at least some of the operations in flowcharts in each embodiment may include a plurality of sub-operations or a plurality of stages. The operations or stages are not necessarily performed at the same moment but may be performed at different moments. Execution of the operations or stages is not necessarily sequentially performed, but may be performed alternately with other operations or at least some operations or stages of other operations.

Based on the same inventive concept, an embodiment of this application further provides a business service establishment apparatus for implementing the foregoing business service establishment method. Implementation solutions provided by the apparatus for solving problems are similar to the implementation solutions described in the foregoing method. Therefore, for specifics one or more business service establishment apparatus embodiments provided below, reference can be made to the descriptions of the business service establishment method in the foregoing descriptions. Details are not repeated.

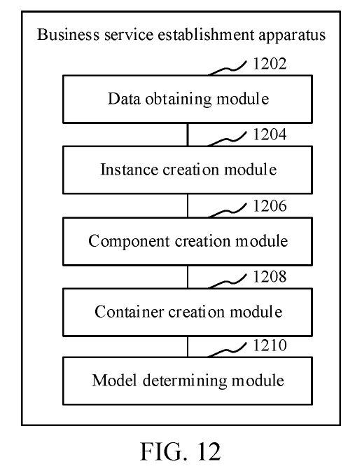

In one embodiment, as shown in FIG. 12, a business service establishment apparatus is provided, including: a data obtaining module 1202, an instance creation module 1204, a component creation module 1206, a container creation module 1208, and a model determining module 1210.

The data obtaining module 1202 is configured to obtain service demand information for a target business service, and obtain an instance template preset for the target business service as a target instance template.

The instance creation module 1204 is configured to create, based on the service demand information and the target instance template, a service instance corresponding to the target business service.

The component creation module 1206 is configured to create a service component based on component claim information included in the service instance, to obtain service components corresponding to the target business service. The component claim information is configured for indicating to create service components respectively matching component types specified by the target instance template.

The container creation module 1208 is configured to create, based on pod claim information included in a service component, a pod set corresponding to the service component, to obtain pod sets respectively corresponding to the service components. The pod claim information included in the service component is obtained from the service instance.

The model determining module 1210 is configured to obtain, based on the service instance, the service components, and the pod sets respectively corresponding to the service components, a service model corresponding to the target business service. The service model is configured for providing the target business service to a demand side corresponding to the service demand information.

In one embodiment, the instance creation module 1204 is further configured to:

fill the target instance template with the service demand information, to obtain a service instance corresponding to the target business service, where the target instance template includes a component claim region and a pod claim region; and the component claim region is configured for indicating component claim information, and the pod claim region is configured for indicating pod claim information.

In one embodiment, the component creation module 1206 is further configured to:

determine, based on the component claim information included in the service instance, component types required by the target business service and component configuration information respectively corresponding to the component types; and separately create, based on the component configuration information, a service component matching the corresponding component type, to obtain the service components corresponding to the target business service.

In one embodiment, the container creation module 1208 is further configured to:

determine, for any one of the service components, a quantity of pods required by the service component based on pod claim information included in the service component, and create to-be-configured pods matching the pods in quantity; determine, based on the pod claim information included in the service component, pod configuration information respectively corresponding to the to-be-configured pods, and initialize the corresponding to-be-configured pods based on the pod configuration information, to obtain configured pods; and obtain, based on the configured pods, the pod set corresponding to the service component.

In one embodiment, the container creation module 1208 is further configured to:

obtain, for any to-be-configured pod by using a pod configuration component, pod runtime identification information corresponding to the to-be-configured pod, and render personalized demand information in pod configuration information corresponding to the to-be-configured pod and the pod runtime identification information, to obtain pod personalized configuration information corresponding to the to-be-configured pod; obtain, by using the pod configuration component, a pod configuration file template corresponding to the target business service, and render the pod personalized configuration information and the pod configuration file template, to obtain a target configuration file corresponding to the to-be-configured pod; and issue the target configuration file to a to-be-configured container by using the pod configuration component, to obtain a configured pod initialized on a configuration file.

In one embodiment, the container creation module 1208 is further configured to:

obtain, by using the pod configuration component, a template index of a pod configuration file template for the target business service from the pod claim information, and obtain the pod configuration file template from a preset storage region based on the template index, where the pod configuration file template is submitted to the preset storage region for storage by using a template unification tool, and the template unification tool is configured for performing format unification on pod configuration file templates respectively provided by a plurality of business developers corresponding to a business type to which the target business service belongs.

In one embodiment, the container creation module 1208 is further configured to:

create a target persistent volume claim matching a storage specification in the pod configuration information; generate a target persistent volume based on a target persistent volume template included in the target persistent volume claim, and associate the target persistent volume with a hard disk matching the storage specification in the pod configuration information; and bind the target persistent volume to the target persistent volume claim, and write the target persistent volume claim into the to-be-configured pod, to obtain a configured pod initialized on the storage specification, where data in the configured pod initialized on the storage specification is configured for writing into the hard disk.

In one embodiment, the business service establishment apparatus is further configured to:

sequentially start the service components based on a service component starting dependency sequence provided by the component claim information; monitor a running state of each service component by using a probe provided for each service component, and trigger, after a probe provided for a service component with a high starting priority detects that each pod in a pod set managed by the service component is successfully started, starting a service component with a next starting priority; and return a creation success message corresponding to the target business service to the demand side after the service components are successfully started.

In one embodiment, the business service establishment apparatus is further configured to:

obtain a pod adjustment request for the target business service, where the pod adjustment request carries a pod adjustment parameter; update, based on the pod adjustment parameter, pod claim information included in the service instance; and update a corresponding service component and a corresponding pod set based on the updated pod claim information.

In one embodiment, the business service establishment apparatus is further configured to:

back up the service instance to obtain a backup instance in a case that destruction of the service instance is triggered; use a pod in the pod set corresponding to each service component as a first pod; create, based on a persistent volume claim corresponding to the first pod, a persistent volume snapshot corresponding to the first pod, create, based on a persistent volume corresponding to the first pod, a persistent volume snapshot content corresponding to the first pod, bind the persistent volume snapshot and the persistent volume snapshot content corresponding to the first pod, generate a data snapshot corresponding to the first pod based on the bound persistent volume snapshot and persistent volume snapshot content corresponding to the first pod, and associatively store pod runtime identification information and the data snapshot corresponding to the first pod; and associatively store the backup instance and the data snapshots respectively corresponding to the pods in the pod sets respectively corresponding to the service components.

In one embodiment, the business service establishment apparatus is further configured to:

obtain the backup instance in a case that restoration of the service instance is triggered; create a service component based on component claim information included in the backup instance, to obtain restoration components; create, based on pod claim information included in the restoration component, a pod set corresponding to the restoration component, to obtain pod sets corresponding to the restoration components; use a pod in the pod set corresponding to each restoration component as a second pod; and obtain a corresponding data snapshot based on pod runtime identification information corresponding to the second pod, generate, based on the data snapshot corresponding to the second pod, a persistent volume snapshot and a persistent volume snapshot content corresponding to the second pod, generate a persistent volume corresponding to the second pod based on the persistent volume snapshot content corresponding to the second pod, generate a persistent volume claim corresponding to the second pod based on the persistent volume snapshot corresponding to the second pod, bind the persistent volume and the persistent volume claim corresponding to the second pod, and apply the persistent volume claim corresponding to the second pod to the second pod.

In one embodiment, the target business service is a target database service. The service instance is configured for indicating metadata required to establish the target database service. The service components are respectively configured for implementing functions possessed by the target database service. The pods belonging to a same pod set cooperate to implement the functions provided by the corresponding service component.

According to the foregoing business service establishment apparatus, instance templates respectively corresponding to various business services are preset, so as to rapidly establish corresponding business services. For a target business service, personalized service demand information of the target business service and an instance template corresponding to the target business service are combined to obtain a service instance corresponding to the target business service. Service components corresponding to the target business service are created based on component claim information included in the service instance. Pod sets corresponding to the service components are created based on the pod claim information included in the service components. A service model for providing the target business service is formed by using the service instance corresponding to the target business service, the service components, and the pod sets respectively corresponding to the service components. The business service is abstracted into a three-layer structure model. The three-layer structure model includes a service instance, service components, and pod sets corresponding to the service components. The service instance manages and creates related information of the service components and the pod sets. The components manage and create related information of the respective pod sets, to implement ordered business service establishment. Various business services may be abstracted into a three-layer structure model. The universality is strong, the universality of business service establishment is ensured, and the efficiency of business service establishment is improved. Based on such a three-layer structure model, the business service is implemented in a cloud native manner.

The modules in the foregoing business service establishment apparatus may be implemented in whole or in part by software, hardware, and a combination thereof. The foregoing modules may be built in or independent of a processor of a computer device in a form of hardware, or may be stored in a memory of the computer device in a form of software, for the processor to invoke to execute operations corresponding to the foregoing modules.

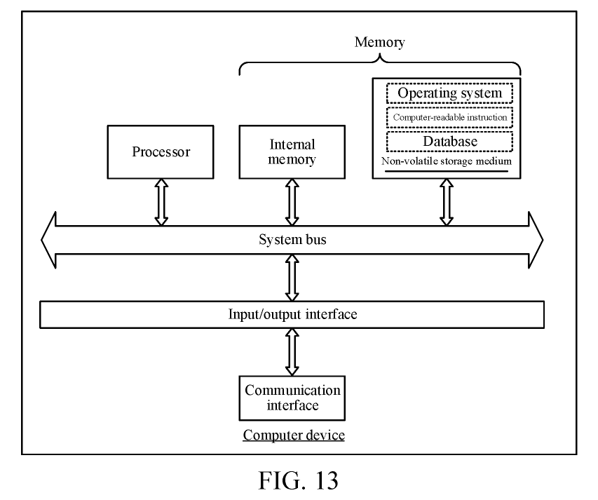

In one embodiment, a computer device is provided. The computer device may be a server, and an internal structure diagram thereof may be shown in FIG. 13. The computer device includes a processor, a memory, an input/output (I/O) interface, and a communication interface. The processor, the memory, and the I/O interface are connected via a system bus. The communication interface is connected to the system bus via the I/O interface. The processor of the computer device is configured to provide computing and control capabilities. The memory of the computer device includes a non-volatile storage medium and an internal memory. The non-volatile storage medium stores an operating system, computer-readable instructions, and a database. The internal memory provides an operating environment for the operating system and the computer-readable instructions in the non-volatile storage medium. The database of the computer device is configured for storing data such as an instance template or a configuration file template. The I/O interface of the computer device is configured for exchanging information between the processor and an external device. The communication interface of the computer device is configured for communicating with an external terminal through a network connection. The computer-readable instructions, when executed by the processor, implement a business service establishment method.

The structure shown in FIG. 13 is merely a block diagram of a partial structure related to a solution in this application, and does not constitute a limitation to the computer device to which the solution in this application is applied. Specifically, the computer device may include more or fewer components than those shown in the figure, or some components may be combined, or a different component layout may be used.

In one embodiment, a computer device is further provided. The computer device includes a memory and a processor. The memory has computer-readable instructions stored therein. The processor, when executing the computer-readable instructions, implements the operations in the foregoing method embodiments.

In one embodiment, a computer-readable storage medium is provided. The computer-readable storage medium has computer-readable instructions stored therein. The computer-readable instructions, when executed by a processor, implement the operations in the foregoing method embodiments.

In one embodiment, a computer program product is provided. The computer program product includes computer-readable instructions. The computer-readable instructions, when executed by a processor, implement the operations in the foregoing method embodiments.

User information (including, but not limited to, user equipment information, user personal information, and the like) and data (including, but not limited to, data for analysis, stored data, displayed data, and the like) involved in this application are all information and data authorized by users or fully authorized by all parties, and collection, use, and processing of relevant data need to comply with relevant laws, regulations, and standards of relevant countries and regions.

A person of ordinary skill in the art may understand that all or some of the procedures of the methods of the foregoing embodiments may be implemented by computer-readable instructions instructing relevant hardware. The computer-readable instructions may be stored in a non-volatile computer-readable storage medium. When the computer-readable instructions are executed, the procedures of the embodiments of the foregoing methods may be included. Any reference to a memory, a database, or another medium used in the embodiments provided in this application may include at least one of a non-volatile memory or a volatile memory. The non-volatile memory may include a read-only memory (ROM), a magnetic tape, a floppy disk, a flash memory, an optical memory, a high-density embedded non-volatile memory, a resistive random access memory (ReRAM), a magnetoresistive random access memory (MRAM), a ferroelectric random access memory (FRAM), a phase change memory (PCM), a graphene memory, or the like. The volatile memory may include a random access memory (RAM) and an external cache. As an illustration rather than a limitation, the RAM is available in various forms, such as a static random access memory (SRAM) or a dynamic random access memory (DRAM). The database involved in the embodiments provided in this application may include at least one of a relational database and a non-relational database. The non-relational database may include a blockchain-based distributed database, or the like, but is not limited thereto. The processor involved in the embodiments provided in this application may be a general-purpose processor, a central processing unit, a graphics processing unit, a digital signal processor, a programmable logic device, a quantum computing-based data processing logic device, or the like, but is not limited thereto.

The technical features of the foregoing embodiments may be randomly combined. To make description concise, not all possible combinations of the technical features in the foregoing embodiments are described. However, the combinations of these technical features shall be considered as falling within the scope recorded by this specification provided that no conflict exists.

The foregoing embodiments only describe several implementations of this application, which are described specifically and in detail, but cannot be construed as a limitation to the patent scope of this application. For a person of ordinary skill in the art, several transformations and improvements may be made without departing from the conception of this application. These transformations and improvements belong to the protection scope of this application. Therefore, the protection scope of this application is required to be subject to the appended claims.

What is claimed is:

1. A business service establishment method, performed by a computer device, comprising:
obtaining service demand information for a target business service;
obtaining an instance template preset for the target business service as a target instance template;
creating, based on the service demand information and the target instance template, a service instance corresponding to the target business service;
creating, based on component claim information included in the service instance, service components corresponding to the target business service and matching component types specified by the target instance template, respectively;
obtaining pod sets corresponding to the service components, respectively, each of the pod sets being created based on pod claim information included in one of the service components that is obtained from the service instance; and
obtaining, based on the service instance, the service components, and the pod sets, a service model corresponding to the target business service and configured for providing the target business service to a demand side corresponding to the service demand information.

2. The method according to claim 1, wherein creating the service instance includes:
filling the target instance template with the service demand information, to obtain the service instance, the target instance template including a component claim region indicating the component claim information and a pod claim region indicating the pod claim information.

3. The method according to claim 1, wherein creating the service components includes:
determining, based on the component claim information, component types required by the target business service and component configuration information corresponding to each of the component types; and
for each component type, creating, based on the component configuration information corresponding to the component type, a service component matching the corresponding component type.

4. The method according to claim 1, wherein creating the pod sets includes, for one service component:
determining a quantity of pods required by the one service component based on pod claim information included in the one service component;
creating candidate pods matching the pods in quantity;
determining, based on the pod claim information included in the one service component, pod configuration information respectively corresponding to the candidate pods;
initializing the corresponding candidate pods based on the pod configuration information, to obtain configured pods; and
obtaining, based on the configured pods, the pod set corresponding to the service component.

5. The method according to claim 4, wherein initializing the corresponding candidate pods includes, for one candidate pod:
obtaining, through a pod configuration component, pod runtime identification information corresponding to the one candidate pod;
rendering personalized demand information in pod configuration information corresponding to the one candidate pod and the pod runtime identification information, to obtain pod personalized configuration information corresponding to the one candidate pod;
obtaining, through the pod configuration component, a pod configuration file template corresponding to the target business service;
rendering the pod personalized configuration information and the pod configuration file template, to obtain a target configuration file corresponding to the one candidate pod; and
issuing the target configuration file to a candidate container through the pod configuration component, to obtain a configured pod initialized on a configuration file.

6. The method according to claim 5, wherein obtaining the pod configuration file template includes:
obtaining, through the pod configuration component and from the pod claim information, a template index of the pod configuration file template for the target business service; and
obtaining the pod configuration file template from a preset storage region based on the template index, the pod configuration file template being submitted to the preset storage region for storage through a template unification tool, and the template unification tool being configured to perform format unification on pod configuration file templates respectively provided by a plurality of business developers corresponding to a business type to which the target business service belongs.

7. The method according to claim 4, wherein initializing the corresponding candidate pods includes, for one candidate pod:
creating a target persistent volume claim matching a storage specification in pod configuration information corresponding to the one candidate pod;
generating a target persistent volume based on a target persistent volume template included in the target persistent volume claim;
associating the target persistent volume with a hard disk matching the storage specification in the pod configuration information;
binding the target persistent volume to the target persistent volume claim; and
writing the target persistent volume claim into the one candidate pod, to obtain a configured pod initialized on the storage specification, data in the configured pod being configured for writing into the hard disk.

8. The method according to claim 1, further comprising:
sequentially starting the service components based on a service component starting dependency sequence provided by the component claim information;
monitoring running states of the service components through probes provided for the service components, respectively;
triggering, after a probe provided for a service component with a high starting priority detects that each pod in a pod set managed by the service component is successfully started, starting a service component with a next starting priority; and
returning a creation success message corresponding to the target business service to the demand side after the service components are successfully started.

9. The method according to claim 1, further comprising:
obtaining a pod adjustment request for the target business service, the pod adjustment request carrying a pod adjustment parameter;
updating, based on the pod adjustment parameter, pod claim information included in the service instance to obtain updated pod claim information; and
updating a corresponding service component and a corresponding pod set based on the updated pod claim information.

10. The method according to claim 1, further comprising:
backing up the service instance to obtain a backup instance in a case that destruction of the service instance is triggered;
for one pod in the pod set corresponding to each service component:
creating, based on a persistent volume claim corresponding to the one pod, a persistent volume snapshot corresponding to the one pod;
creating, based on a persistent volume corresponding to the one pod, a persistent volume snapshot content corresponding to the one pod;
binding the persistent volume snapshot and the persistent volume snapshot content corresponding to the one pod;
generating a data snapshot corresponding to the one pod based on the bound persistent volume snapshot and persistent volume snapshot content corresponding to the one pod; and
associatively storing pod runtime identification information and the data snapshot corresponding to the one pod; and
associatively storing the backup instance and the data snapshots respectively corresponding to the pods in the pod sets respectively corresponding to the service components.

11. The method according to claim 10,
wherein the one pod in the pod set corresponding to each service component is a first pod;
the method further comprising:
obtaining the backup instance in a case that restoration of the service instance is triggered;
obtaining restoration components based on component claim information included in the backup instance;
creating pod sets corresponding to the restoration components, respectively, based on pod claim information included in the respective restoration components;
for a second pod in the pod set corresponding to each restoration component:
obtaining a corresponding data snapshot based on pod runtime identification information corresponding to the second pod;
generating, based on the data snapshot, a persistent volume snapshot and a persistent volume snapshot content corresponding to the second pod;
generating a persistent volume corresponding to the second pod based on the persistent volume snapshot content;
generating a persistent volume claim corresponding to the second pod based on the persistent volume snapshot;
binding the persistent volume and the persistent volume claim; and
applying the persistent volume claim to the second pod.

12. The method according to claim 1, wherein:
the target business service includes a target database service;
the service instance is configured to indicate metadata required to establish the target database service;
the service components are configured to implement functions possessed by the target database service, respectively; and
the pods belonging to a same pod set cooperate to implement the functions provided by the corresponding service component.

13. A computer device comprising:
a memory storing computer-readable instructions; and
a processor configured to execute the computer-readable instructions to:
obtain service demand information for a target business service;
obtain an instance template preset for the target business service as a target instance template;
create, based on the service demand information and the target instance template, a service instance corresponding to the target business service;
create, based on component claim information included in the service instance, service components corresponding to the target business service and matching component types specified by the target instance template, respectively;
obtain pod sets corresponding to the service components, respectively, each of the pod sets being created based on pod claim information included in one of the service components that is obtained from the service instance; and
obtain, based on the service instance, the service components, and the pod sets, a service model corresponding to the target business service and configured for providing the target business service to a demand side corresponding to the service demand information.

14. The computer device according to claim 13, wherein the processor is further configured to execute the computer-readable instructions to, when creating the service instance:
fill the target instance template with the service demand information, to obtain the service instance, the target instance template including a component claim region indicating the component claim information and a pod claim region indicating the pod claim information.

15. The computer device according to claim 13, wherein the processor is further configured to execute the computer-readable instructions to, when creating the service components:
determine, based on the component claim information, component types required by the target business service and component configuration information corresponding to each of the component types; and
for each component type, create, based on the component configuration information corresponding to the component type, a service component matching the corresponding component type.

16. The computer device according to claim 13, wherein the processor is further configured to execute the computer-readable instructions to, when creating the pod sets, for one service component:
determine a quantity of pods required by the one service component based on pod claim information included in the one service component;
create candidate pods matching the pods in quantity;
determine, based on the pod claim information included in the one service component, pod configuration information respectively corresponding to the candidate pods;
initialize the corresponding candidate pods based on the pod configuration information, to obtain configured pods; and
obtain, based on the configured pods, the pod set corresponding to the service component.

17. The computer device according to claim 16, wherein the processor is further configured to execute the computer-readable instructions to, when initializing the corresponding candidate pods, for one candidate pod:
obtain, through a pod configuration component, pod runtime identification information corresponding to the one candidate pod;
render personalized demand information in pod configuration information corresponding to the one candidate pod and the pod runtime identification information, to obtain pod personalized configuration information corresponding to the one candidate pod;
obtain, through the pod configuration component, a pod configuration file template corresponding to the target business service;
render the pod personalized configuration information and the pod configuration file template, to obtain a target configuration file corresponding to the one candidate pod; and
issue the target configuration file to a candidate container through the pod configuration component, to obtain a configured pod initialized on a configuration file.

18. The computer device according to claim 17, wherein the processor is further configured to execute the computer-readable instructions to, when obtaining the pod configuration file template:
obtain, through the pod configuration component and from the pod claim information, a template index of the pod configuration file template for the target business service; and
obtain the pod configuration file template from a preset storage region based on the template index, the pod configuration file template being submitted to the preset storage region for storage through a template unification tool, and the template unification tool being configured to perform format unification on pod configuration file templates respectively provided by a plurality of business developers corresponding to a business type to which the target business service belongs.

19. The computer device according to claim 16, wherein the processor is further configured to execute the computer-readable instructions to, when initializing the corresponding candidate pods, for one candidate pod:
create a target persistent volume claim matching a storage specification in pod configuration information corresponding to the one candidate pod;
generate a target persistent volume based on a target persistent volume template included in the target persistent volume claim;
associate the target persistent volume with a hard disk matching the storage specification in the pod configuration information;
bind the target persistent volume to the target persistent volume claim; and
write the target persistent volume claim into the one candidate pod, to obtain a configured pod initialized on the storage specification, data in the configured pod being configured for writing into the hard disk.

20. A non-transitory computer-readable storage medium storing computer-readable instructions that, when executed by a processor, cause the processor to:
obtain service demand information for a target business service;
obtain an instance template preset for the target business service as a target instance template;
create, based on the service demand information and the target instance template, a service instance corresponding to the target business service;
create, based on component claim information included in the service instance, service components corresponding to the target business service and matching component types specified by the target instance template, respectively;
obtain pod sets corresponding to the service components, respectively, each of the pod sets being created based on pod claim information included in one of the service components that is obtained from the service instance; and
obtain, based on the service instance, the service components, and the pod sets, a service model corresponding to the target business service and configured for providing the target business service to a demand side corresponding to the service demand information.
